(19) United States
(12) Patent Application Publication
(10) Pub. No.: US 2024/0302841 A1
(43) Pub. Date: Sep. 12, 2024

(54) RETURN FLIGHT METHOD AND APPARATUS OF UNMANNED AERIAL VEHICLE, UNMANNED AERIAL VEHICLE, REMOTE CONTROL DEVICE, SYSTEM, AND STORAGE MEDIUM

(71) Applicant: SZ DJI TECHNOLOGY CO., LTD., Shenzhen (CN)

(72) Inventor: Zezao LU, Shenzhen (CN)

(73) Assignee: SZ DJI TECHNOLOGY CO., LTD., Shenzhen (CN)

(21) Appl. No.: 18/655,213

(22) Filed: May 3, 2024

Related U.S. Application Data
(63) Continuation of application No. PCT/CN2021/128566, filed on Nov. 4, 2021.

(51) Int. Cl. G05D 1/227; G05D 1/246; G05D 1/622; G05D 1/82; G05D 1/85; G05D 1/86; G05D 109/20

(52) U.S. Cl. CPC G05D 1/2278; G05D 1/2274; G05D 1/2462; G05D 1/622; G05D 1/82; G05D 1/852; G05D 1/857; G05D 1/86; G05D 2109/20

(57) ABSTRACT

A return method and device for an aerial vehicle are provided. The method includes: during a flight process of the aerial vehicle, performing real-time planning on a return path from a current position of the aerial vehicle to a return position; performing real-time transmission of the return path to a terminal device to display the return path on a display interface. The aerial vehicle plans the return path in real-time during flight and sends it in real-time to the terminal device for display. This allows users to timely understand the planned return path of the aerial vehicle. Even in the event of a loss of connection between the aerial vehicle and the terminal device, the terminal device can display the return path based on the previously received information, thereby enhancing the safety of aerial vehicle return.

### RELATED APPLICATIONS

This application is a continuation application of PCT application No. PCT/CN2021/128566, filed on Nov. 4, 2021, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technical field of aerial vehicles, and specifically, to a return flight method and apparatus of an aerial vehicle.

### BACKGROUND

An aerial vehicle such as an unmanned aerial vehicle (UAV) is an unmanned aircraft operated with radio remote control equipment and its own program control device, or operated fully or intermittently autonomously by an onboard computer. UAVs are widely used in aerial photography, agricultural plant protection, micro selfies, express transportation, disaster rescue, observing wild animals, monitoring infectious diseases, surveying and mapping, news reporting, power inspections, disaster relief, film and television shooting and other scenarios.

When a UAV returns after completing its flight mission, it can return under the control of a user, or autonomous return under specific conditions, where the safety of the return of UAV has always been a concern in the industry.

### SUMMARY

In view of the foregoing, one object of present disclosure is to provide a return flight method and apparatus of an aerial vehicle.

In one aspect, embodiments of the present disclosure provide a return method for an aerial vehicle, including: during a flight process of the aerial vehicle, performing real-time planning of a return path from a current position to a return position; and performing real-time transmission of the return path to a terminal device to display the return path on a display interface.

In another aspect, embodiments of the present disclosure provide a return method applicable to a terminal device of an aerial vehicle, including: receiving a return path from a current position of the aerial vehicle to a return position sent in real-time by the aerial vehicle, where the return path is planned in real-time by the aerial vehicle during a flight process; and displaying the return path on a display interface of the terminal device.

In yet another aspect, embodiments of the present disclosure provide an aerial vehicle, including: a body; a propulsion system located within the body to provide flight power to the aerial vehicle; and a control device within the body, including: at least one storage medium storing at least one set of instructions for aerial vehicle return; and at least one processor in communication with the at least one storage medium, where during operation, the at least one processor executes the at least one set of instructions to cause the control device to at least: during a flight process of the aerial vehicle, perform real-time planning of a return path from a current position to a return position, and perform real-time transmission of the return path to a terminal device to display the return path on a display interface.

The return method for an aerial vehicle provided in some exemplary embodiments of the present disclosure implements real-time planning of a return path during the flight of the aerial vehicle and sends the return path to the terminal device for display in real-time, so that a user can be aware of the planned return path of the aerial vehicle in time. Even if the aerial vehicle loses communication with the terminal device, the terminal device can still display the return path received before the communication is lost, which is beneficial for improving the safety of the UAV's return flight.

### BRIEF DESCRIPTION OF THE DRAWINGS

In order to clearly illustrate the technical solutions of the embodiments of the present disclosure, the following will briefly introduce the drawings for the description of some exemplary embodiments. Apparently, the accompanying drawings in the following description are some exemplary embodiments of the present disclosure. For a person of ordinary skill in the art, other drawings may also be obtained based on these drawings without creative efforts.

FIG. 1 is a schematic diagram of an unmanned aerial system according to some embodiments of the present disclosure;

FIG. 2 is a schematic diagram of a terminal device according to some embodiments of the present disclosure;

FIG. 3 is a schematic diagram of a terminal device according to some embodiments of the present disclosure;

FIG. 4 is a flowchart of a UAV return method according to some embodiments of the present disclosure;

FIG. 5 is a schematic diagram of a return path display according to some embodiments of the present disclosure;

FIG. 6A is a schematic diagram of a grid map according to some embodiments of the present disclosure;

FIG. 6B is a schematic diagram of a grid map according to some embodiments of the present disclosure;

FIG. 7 is a schematic diagram of a historical flight trajectory and surrounding obstacle information according to some embodiments of the present disclosure;

FIG. 8 is a schematic diagram of a UAV performing diagonal descent according to some embodiments of the present disclosure;

FIG. 9 is a schematic diagram of a return path display according to some embodiments of the present disclosure;

FIGS. 10A, 10B, and 10C are schematic diagrams illustrating different displays when there is a discrepancy between a real-time position and a starting point of a return path according to some embodiments of the present disclosure; and

FIG. 11 is a schematic diagram of the structural design of a control device according to some embodiments of the present disclosure.

### DETAILED DESCRIPTION

The technical solutions in some exemplary embodiments of the present disclosure will be described below with reference to the accompanying drawings in the embodiments of the present disclosure. Obviously, the described embodiments are part of the embodiments of the present disclosure, but not all of the embodiments. Based on the exemplary embodiments in the present disclosure, all other embodiments obtained by a person of ordinary skill in the art without creative efforts fall within the scope of protection of the present disclosure.

Some exemplary embodiments of the present disclosure show the optimization for the return of a UAV for real-time planning of a return path during UAV flight and real-time transmission of the return path to a terminal device for display.

It would be apparent to a person skilled in the art any type of UAV can be used without limitation. Embodiments of the present disclosure can be applied to various types of UAVs. For example, the UAVs herein can be small or large ones. In some exemplary embodiments, UAVs can be rotorcraft, such as multirotor UAVs propelled by the air with multiple propulsion devices. However, embodiments of the present disclosure are not limited to this; the UAVs can also be of other types (it is noted that UAV is merely an example of the application of the present disclosure, the present disclosure covers any type of aerial vehicle and aircraft).

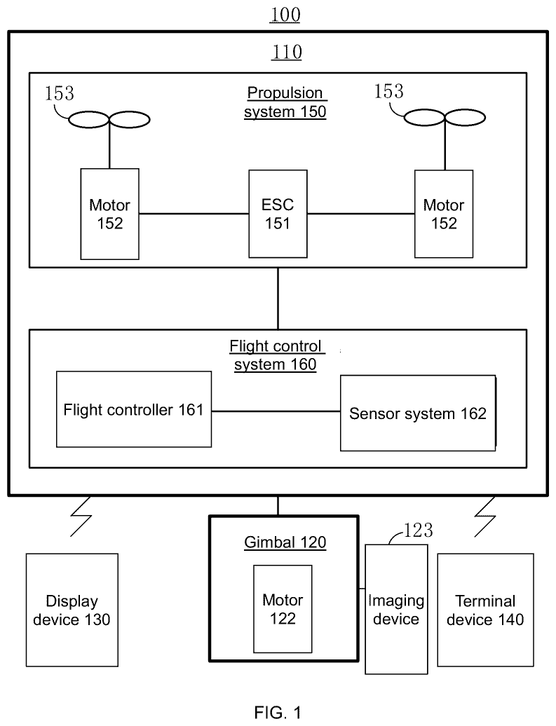

FIG. 1 is a schematic architectural diagram of an unmanned aerial system according to some exemplary embodiments of the present disclosure. This embodiment is illustrated using a rotorcraft UAV as an example.

The unmanned aerial system 100 may include a UAV 110, a display device 130, and a terminal device 140. Among them, the UAV 110 may include a propulsion system 150, a flight control system 160, a frame, and a gimbal 120 carried on the frame. The UAV 110 may communicate wirelessly with the terminal device 140 and the display device 130. The UAV 110 can be an agricultural UAV or an industrial application UAV, which requires cyclic operations.

The frame may include a body and a landing gear. The body may include a center frame and one or more arms connected to the center frame, and the one or more arms extend radially from the center frame. The landing gear can be connected to the body to support the UAV 110 when it lands.

The propulsion system 150 may include one or more electronic speed controllers (referred to as ESCs) 151, one or more propellers 153, and one or more motors 152 corresponding to the one or more propellers 153. The motor 152 is connected between the electronic speed controller 151 and the propeller 153, and both the motors 152 and the propellers 153 are mounted on the arms of the UAV 110. The electronic speed controller 151 is used to receive drive signals generated by the flight control system 160 and provide drive currents to the motors 152 according to these signals to control the speed of the motors 152. The motors 152 are used to drive the rotation of the propellers, thereby providing flight power for the flight of the UAV 110, enabling the UAV 110 to achieve one or more degrees of freedom in motion. In some exemplary embodiments, the UAV 110 can rotate about one or more axes. For example, these axes may include roll, yaw, and pitch axes. It should be understood that the motor 152 can be a DC motor or an AC motor. Additionally, the motor 152 can be a brushless motor or a brushed motor.

The flight control system 160 may include a flight controller 161 and a sensor system 162. The sensor system 162 can be used to measure the attitude information of the UAV, including spatial position and status information such as three-dimensional position, three-dimensional angle, three-dimensional velocity, three-dimensional acceleration, and three-dimensional angular velocity, etc. The sensor system 162 may include at least one sensor, such as gyroscopes, ultrasonic sensors, electronic compasses, inertial measurement units (IMUs), vision sensors, global navigation satellite systems, and barometers. For instance, the global navigation satellite system can be the Global Positioning System (GPS). The flight controller 161 is responsible for controlling the flight of the UAV, for example, it can control the flight of the UAV based on the attitude information measured by the sensor system 162. It should be understood that the flight controller 161 can control the UAV according to pre-programmed instructions or respond to one or more remote control signals from the terminal device 140.

The gimbal 120 may include a motor(s) 122. The gimbal is used to carry an imaging device 123. The flight controller 161 can control the movement of the gimbal 120 via the motor 122. Alternatively, in some exemplary embodiments, the gimbal 120 may also include a controller used to control the movement of the gimbal 120 by controlling the motor 122. It should be understood that the gimbal 120 can be independent of the UAV 110 or part of the UAV 110. The motor 122 can be a DC motor or an AC motor. Additionally, the motor 122 can be a brushless motor or a brushed motor. It should also be understood that the gimbal can be positioned at the top or bottom of the UAV.

The imaging device 123, for example, can be a camera or a video camera used to capture images. The imaging device 123 can communicate with the flight controller and capture images under the control of the flight controller. The imaging device 123 herein may include at least a photosensitive element, which can be a Complementary Metal Oxide Semiconductor (CMOS) sensor or a Charge-coupled Device (CCD) sensor. It can be understood that the imaging device 123 can also be directly mounted on the UAV 110, thereby eliminating the need for the gimbal 120.

The display device 130 is located at a ground end of the unmanned aerial system 100. It can communicate wirelessly with the UAV 110 and can be used to display the attitude information of the UAV 110. Additionally, the images captured by the imaging device 123 can be displayed on the display device 130. It should be understood that the display device 130 can be a standalone device or integrated into the terminal device 140.

The terminal device 140 is located at the ground end of the unmanned aerial system 100. It can communicate wirelessly with the UAV 110 and is used to remotely control the UAV 110.

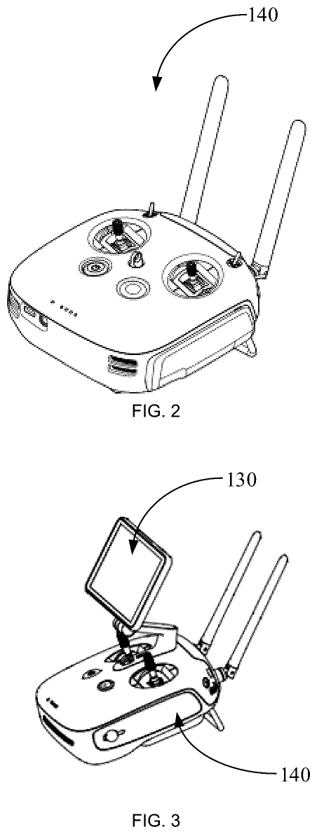

Exemplarily, the display device 130 and the terminal device 140 are separate devices, for example, the display device 130 could be a mobile terminal (such as a smartphone, tablet, etc.), as shown in FIG. 2, while the terminal device 140 could be a terminal device with two joysticks. For instance, the display device 130 could also be integrated into the terminal device 140, as shown in FIG. 3, where a terminal device with a screen and a joystick(s) is depicted. Alternatively, the display device could be a mobile terminal (such as a smartphone, for example, by installing relevant software applications on the phone, thus enabling the display of UAV images captured by the imaging device and receiving user touch operations for the UAV via the touch screen).

It should be understood that the naming of various components of the unmanned aerial system above is for identification purposes only and should not be construed as limiting the embodiments of the present disclosure.

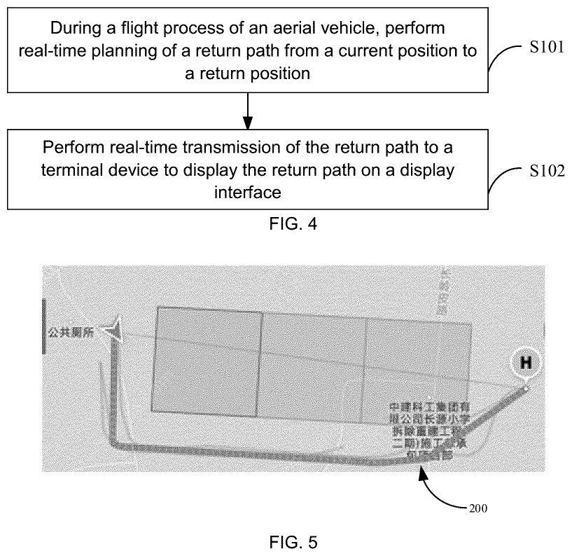

The UAV can return under user control or autonomously under specific conditions. With reference to FIG. 4, which illustrates a flowchart of a return method for a UAV, this method can be applied to a UAV, and it can be executed by a flight controller of the UAV as shown in FIG. 1. The method may include:

Step S101, during a flight process of a UAV, performing real-time planning on a return path from a current position of the UAV to a return position.

Step S102, performing real-time transmission of the return path to a terminal device to display the return path on a display interface.

In some exemplary embodiments, the UAV is capable of dynamically planning (in real-time) the return path during flight and transmitting this path in real-time to be displayed on the terminal device. This allows users to promptly understand the planned return path of the UAV. Even in situations where the UAV loses connection with the terminal device, the terminal device can still display the previously received return path, thereby enhancing the safety of UAV return.

In some exemplary embodiments, the initiation timing for planning the return path of the UAV is described as follows: the UAV can commence real-time planning of the return path from its current position to the return position under predetermined conditions. These conditions may include but are not limited to, the UAV taking off, just before the trigger for the return, the distance between the UAV and the return position being greater than a preset distance, or the UAV's flight time exceeding a preset duration. These conditions are illustrative and not exhaustive, and can be tailored based on the specific application scenarios.

Exemplarily, taking the return position as the takeoff point as an example, the UAV begins real-time planning of the return path from its current position to the return position after the UAV has flown more than 5 meters away from the takeoff point. The return position can be either the takeoff point or another location set by the user. In some exemplary embodiments, if the distance between the UAV and the return position is less than a preset distance when triggering the return, the UAV may directly land. Therefore, by initiating real-time planning of the return path when the distance between the UAV and the return position is greater than the preset distance, the computational workload can be reduced.

Exemplarily, after the UAV takes off, it begins real-time planning of the return path from its current position to the return position. Then, it stops planning the return path after the return is triggered, or it adjusts the return path in real-time after the return is triggered. For instance, if the UAV is equipped with sensors capable of obstacle avoidance, it can adjust the return path in real-time based on the detection data from these sensors, thereby enhancing both the efficiency and safety of the return, provided that the sensors are operating normally.

Considering factors such as increasing flight distance or complexity in the flight environment (such as numerous obstacles), the UAV may require a certain amount of time to plan the return path on each occasion. Therefore, real-time planning of the return path for the UAV can be understood as follows: the UAV plans the return path at a certain frequency, where the frequency is determined based on the time required for the UAV to plan the return path on each occasion. For example, if it takes 10 seconds for the UAV to plan the return path, it may plan the return path at a frequency of 6 times per minute.

After the UAV has planned the return path, it may transmit the return path to the terminal device in real-time. The transmission frequency of the return path from the UAV to the terminal device can be greater than or equal to the planning frequency of the return path by the UAV. When the transmission frequency is greater than the planning frequency, if the UAV has not yet planned the return path at the current moment, it can send the historical return path planned in the last session to the terminal device. When both frequencies are the same, the UAV sends the latest planned return path each time.

It is understandable that embodiments of the present disclosure do not impose any restrictions on the form of sending the return path, and specific settings can be made based on the actual application scenarios. For example, the return path sent by the UAV can include at least the positional information of the waypoints along the return path. Furthermore, it can also include additional information such as velocity and/or orientation at the waypoints. Additionally, the return path sent by the UAV can also include polynomial trajectories corresponding to the return path.

After receiving the return path, the remote control terminal can display the return path on the display interface. In one example, as shown in FIG. 5, the return path 200 can be superimposed and displayed on a map corresponding to the current environment of the UAV. In another example, the return path can also be superimposed and displayed on the real-time footage captured by the UAV. In yet another example, the return path, a map corresponding to the current environment of the UAV, and a three-dimensional model obtained from the reconstruction of the UAV's current environment can all be superimposed and displayed together. It is understandable that the embodiments of the present disclosure do not impose any restrictions on the display method of the return path on the terminal device, and specific settings can be made based on the actual application scenarios.

Exemplarily, when the UAV is about to return, the terminal device can respond to the return trigger instruction of the UAV and display the return path on the display interface. This allows users to promptly understand the return situation of the UAV based on the displayed return path, thereby enhancing the safety of UAV return.

Since the UAV plans the return path in real-time and sends it in real-time to the terminal device, the terminal device can respond to the return trigger instruction of the UAV and display the most recently received return path on the display interface. Additionally, during the return process, the terminal device can also display subsequent updated return paths on the display interface.

The conditions triggering the UAV's return may include: the user initiates the return, the remaining battery level of the UAV falls below a low power threshold, or the UAV loses connection with the terminal device. The loss of connection between the UAV and the terminal device can involve the loss of communication and/or video transmission signals. In cases where the user triggers the return, the remaining battery level of the UAV falls below the low power threshold, or the UAV loses connection with the terminal device, the UAV can execute the return according to the return path.

In some exemplary embodiments, the UAV is equipped with sensors capable of obstacle avoidance. If these sensors are functioning properly, the UAV can plan in real-time the return path from its current position to the return position based on the detection data from these sensors. Therefore, during the execution of the return according to the planned return path, the UAV can navigate around obstacles, ensuring a safe return.

Exemplarily, the sensors used for obstacle avoidance include, but are not limited to, vision sensors, LiDARs (Light Detection and Ranging), millimeter-wave radars, or ultrasonic radars. Depending on the specific application scenario, one of these sensors' detection data can be selected for return path planning, or the data from at least two sensors can be combined for return path planning. The conditions for the normal operation of these sensors include: the internal components of the sensors are functioning properly, and external factors have minimal impact on the sensors, allowing them to collect detection data that meets predefined requirements. For example, for vision sensors to operate normally, the ambient light brightness needs to meet the working conditions of the vision sensor, assuming the internal components of the visual sensor are intact. Similarly, considering the influence of environmental factors such as haze or dust storms on the LiDAR, where laser pulses emitted by LiDAR may struggle to penetrate fog, smoke, or dust particles, resulting in weak return signals, the normal operation of LiDAR may require the UAV to be in an environment free from haze or dust storms.

In some exemplary embodiments, during the planning of the return path, considering that grid maps are advantageous for planning the shortest return path but may include some grids in an unknown state, relying solely on the return path planned based on the grid map may not be sufficiently safe. Therefore, the UAV determines the grid map and road network map of its environment based on the detection data from the sensors. Then, it plans the return path in real-time from its current position to the return position based on both the grid map and the road network map. In some exemplary embodiments, the grid map may include multiple grids, with each grid associated with a first cost coefficient that characterizes the safety risk of passing through that grid. The road network map includes multiple edges, with each edge associated with a second cost coefficient that characterizes the safety risk of passing through that edge. By combining the grid map and the road network map for return path planning, the UAV can evaluate the safety of the planned return path based on the road network map, where multiple edges represent predefined, relatively safe trajectories (such as those flown by this UAV or other UAVs in historical time periods). At the same time, utilizing the grid map enables the UAV to plan the shortest return path from the current position to the return position. Integrating these two approaches allows the UAV to plan a return path that balances both return efficiency and safety.

Exemplarily, to enhance the accuracy of the grid map, besides being determined based on the detection data from the sensors, the grid map can also be determined by combining at least one of the following data: terrain elevation maps of the UAV's environment, no-fly zone maps, or grid maps of the environment obtained by other UAVs. This helps improve the accuracy of the grid map. The first cost coefficient associated with each grid can be determined based on at least one of the following pieces of information: occupancy probability of the grid, whether the grid belonging to a no-fly zone, localization accuracy or communication quality at the location of the grid. A higher first cost coefficient indicates a higher safety risk for the UAV passing through the grid, and therefore, the UAV should avoid grids with the high cost coefficients during path planning.

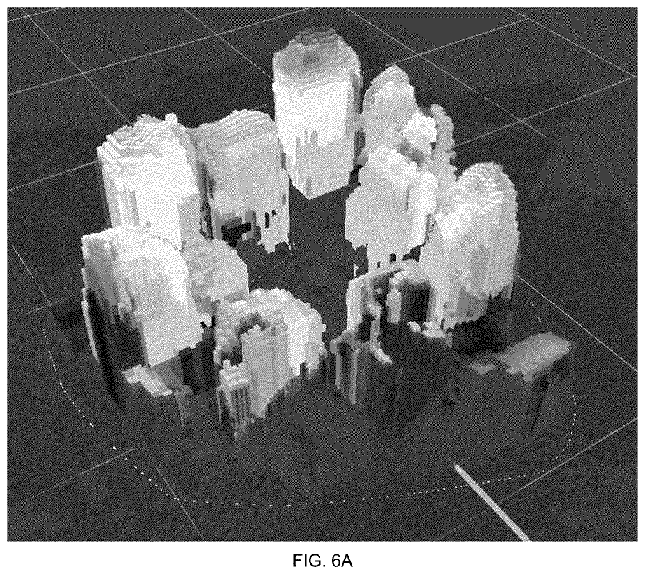

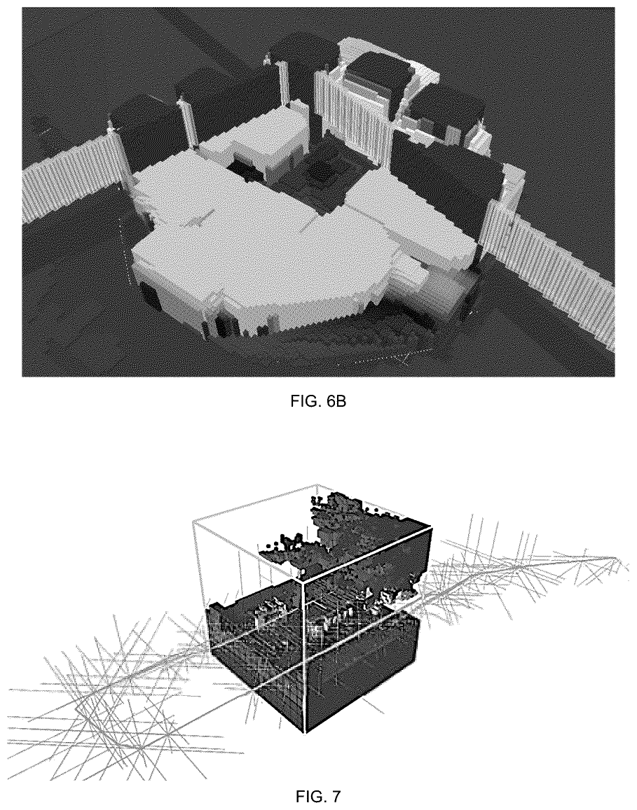

In one example, taking the determination of the grid map combined with the no-fly zone map as an example, FIG. 6A depicts the grid map generated based on the detection data from the sensors. If it is determined from the no-fly zone map that one or more grids in the grid map are located within a no-fly zone, the occupancy probability of these grids can be increased. For instance, as shown in FIG. 6B, the grid map is generated based on both the no-fly zone map and the detection data from the sensors. This enables subsequent path planning for return to avoid grids within the no-fly zone, thereby enhancing the accuracy of the return path planning.

Exemplarily, the road network map may include multiple road network nodes and edges connecting these nodes. The road network nodes include three-dimensional positional information, while the edges include the flight path between two connected road network nodes, flight parameters (such as velocity information, pose information, and the time required for the flight path), and the second cost coefficient. The second cost coefficient represents the safety risk associated with traversing the edge. The second cost coefficient can be determined based on information such as the localization accuracy and/or communication quality corresponding to the flight path. A higher second cost coefficient indicates a higher safety risk for the UAV traversing the edge, and therefore, the UAV should carefully select the flight path corresponding to the edge during path planning.

In some examples, with reference to FIG. 7, it illustrates the historical flight trajectory 300 of the UAV and obstacle information surrounding this trajectory. The obstacle information around the historical flight trajectory can be determined based on the detection data from the sensors as the UAV flies along the historical flight trajectory. For example, in FIG. 7, the thin lines around the historical flight trajectory represent the distances between the trajectory and obstacles. At least some of the road network maps can be derived based on the UAV's historical flight trajectory and the detection data from the sensors as the UAV flies along this trajectory. In some exemplary embodiments, storing and incorporating the historical flight trajectory of the UAV and obstacle information surrounding it into map construction reduces the amount of data required for storage or computation compared to a global map (such as a complete map of the UAV's environment). Compared to a local map (such as a map within a predefined range around the UAV, such as the cuboid-shaped local grid map shown in FIG. 7), it contains more comprehensive information (such as obstacle information), thus improving the accuracy of map construction.

To enhance the accuracy of the determined road network maps, some of the road network maps can also be determined based on preset safe flight paths in the environment where the UAV is located. These preset safe flight paths can be historical flight trajectories of other UAVs or flight paths pre-planned based on detection data collected by other sensing tools.

In some exemplary embodiments, during the process of planning the return path using grid maps and road network maps, the UAV can employ a search-based method to explore paths in both the grid map and the road network map to obtain the return path. Subsequently, the UAV can utilize a sampling-based method to optimize the return path in the road network map. In some exemplary embodiments, after planning the return path based on the search-based method, further adjustments may be made to the return path using the sampling-based method to obtain a finer return path with a smaller overall cost. This approach ensures that the planned return path balances both return efficiency and return safety.

During the path search process, the nodes being searched include the grids in the grid map and the road network nodes in the road network map. When searching for adjacent nodes to these nodes, the adjacent nodes include the neighboring grids in the global grid map and the road network nodes within a preset radius of the node in a global road network map. In the process of optimizing the return path, the return path along with the nodes and edges of the global road network map are added to the tree structure of the Rapidly-exploring Random Tree (RRT). The RRT*-Smart algorithm is then employed to optimize the return path. Starting from the leaf nodes, the algorithm continuously checks whether it is possible to connect to the parent node without obstacles. If a direct connection to the parent node is possible, it is preferred, potentially resulting in a more direct path with fewer curves and additional straight sections.

Understandably, in some exemplary embodiments, no specific restrictions are imposed on the exact methods for the search-based and sampling-based approaches, allowing for specific choices based on actual application scenarios. For instance, the search-based method could utilize algorithms such as A* or LPA*, while the sampling-based method could involve algorithms like RRT, RRT*, or RRT-smart, among others.

In one example, taking the A* algorithm as an example of the search-based method, the A* algorithm calculates the priority of each node using the function f(n)=g(n)+h(n), where f(n) represents the combined priority of a node n. When selecting the next node to traverse, the algorithm always chooses the node with the highest priority (i.e., the smallest value of f(n)). Herein, g(n) represents the cost from the starting point (i.e., the current position of the UAV) to node n, while h(n) represents the estimated cost from node n to the goal point (i.e., the return position). This h(n) is also known as the heuristic function of the A* algorithm. During operation, A* selects the node with the smallest f(n) value (highest priority) from the priority queue as the next node to traverse. It maintains an open_set to represent nodes that are yet to be traversed and a close_set to represent nodes that have been traversed.

A user can use the A* algorithm to search for the return path in both the grid map and the road network map: initialize open_set and close_set; then add the starting point to the open_set, and set f(n)=g(n)+h(n), where g(n) of the starting point is 0, and h(n) is the heuristic cost from the starting point to the end point, for example, h(n) can be determined based on the product of the Euclidean distance between two points and a cost factor; if open_set is not empty, select the node n with the smallest f(n) value from open_set: if node n is the endpoint, start tracking the parent node from the endpoint step by step until reaching the starting point; return the found result path, and the algorithm ends; if node n is not the endpoint, remove node n from open_set and add it to close_set; traverse all neighboring nodes of node n, where all neighboring nodes of node n include adjacent grids in the global grid map and road network nodes within the preset radius of node n in the global road network map: if neighboring node m is in close_set, skip and select the next neighboring node; if neighboring node m is not in open_set, set the parent of node m as node n; calculate f(m)=g(m)+h(m) for node m, for example, g(m) of this node is the g value of the parent node plus the movement cost from the parent node to this node; if both the parent and this node are road network nodes in the road network map, and there is an edge between these two nodes in the road network map, the movement cost is the cost of the corresponding edge in the road network map (i.e., the second cost factor), otherwise, use the grid map to calculate the movement cost between the two nodes. The boundary of the grid naturally divides the straight line between two nodes into multiple line segments, and each line segment is within a grid, and each grid has its own first cost factor, so the movement cost of each line segment is the length of the segment multiplied by the first cost factor of the grid; then add node m to open_set.

In some exemplary embodiments, when the obstacle avoidance sensor(s) is functioning properly, the UAV plans the return path based on the sensor(s)'s detection data. The UAV responds to the return trigger instruction and executes the return according to the planned return path. During this process, if the UAV receives a first control command sent by the terminal device, which is used to control the orientation/direction of the aircraft, left/right flight, or flight altitude, considering the complexity of the flight environment, overlaying user-imposed control commands related to changing the attitude during the return flight along the planned return path may lead to the UAV flying to extreme positions where it cannot return or may collide with obstacles. Therefore, to ensure the safety of the UAV's return, the UAV may not respond to the first control command sent by the terminal device. In other words, during the UAV's return flight along the return path, the user cannot adjust the UAV's flight direction, attitude, etc.

During the UAV's execution of the return along the planned return path, while the user cannot adjust the UAV's flight direction or attitude, the UAV can respond to a second control command sent by the terminal device to control the flight speed. This means that the user can adjust the UAV's flight speed using the terminal device while the UAV is returning along the planned path.

Exemplarily, as shown in FIGS. 2 and 3, the terminal device features two joysticks for maneuvering the UAV. During the UAV's flight mission, a user can control various aspects such as the UAV's heading, left/right (lateral) movement (such as rightward or leftward translation), altitude, or flight speed using these joysticks. The terminal device generates and sends flight control commands to the UAV based on the user's joystick operations, controlling the UAV's attitude and/or speed. However, during the UAV's return along the planned path, considering the complexity of the flight environment, overlaying user-inputted control commands related to attitude changes could potentially lead the UAV to extreme positions where it cannot return or collide with obstacles. Therefore, during the return process, user manipulation of the joysticks can control the UAV's flight speed along the return path but cannot alter the heading, lateral movement, or altitude, thereby ensuring the safety of the UAV's return.

When controlling the UAV's flight speed, for example, users can increase the UAV's flight speed by pushing up on the joystick or decrease it by pulling down on the joystick. The terminal device generates the second control command based on the user's joystick operation to control the UAV's flight speed.

Furthermore, considering that the UAV typically flies at a preset speed when returning along the designated return path, where the preset speed indicates the flight speed corresponding to maximum flight range, deviation of the indicated speed from this preset speed, either higher or lower, may accelerate the UAV's power consumption. If the difference between the speed indicated by the second control command and the preset speed exceeds a certain threshold, a first indication message can be sent to the terminal device to display a warning message on the display interface/screen, alerting the user to the increased power consumption. This is to prevent UAV return failure due to low battery during low battery return. The threshold for the speed difference can be set based on the specific application scenario, with no restrictions imposed herein. The warning message may include, but is not limited to, visual or auditory information.

In some exemplary embodiments, if the obstacle avoidance sensor fails during UAV flight, the UAV can dynamically plan the return path in real-time from its current position to the return position based on the distance between the current position and the return position in real-time. For example, the return path can be a straight line path between the UAV's current position and the return position. The obstacle avoidance sensor may fail due to internal factors such as aging, wear, or damage to certain internal components of the sensor. Alternatively, external factors may affect the failure of the obstacle avoidance sensor, such as environmental conditions preventing the sensor from collecting detection data that meets the preset requirements. The preset requirements indicate that the sensor's detection data should be able to effectively detect obstacles. For example, obstacle avoidance sensors may include vision sensors, LiDARs, etc. Vision sensors may fail if the ambient light brightness does not meet the preset working conditions, while LiDARs may fail due to conditions like haze/fog or dust storms.

Exemplarily, if the distance between the current position of the UAV and the return position is less than a distance threshold, the return path includes flying in a straight line to a position directly above the return position at the UAV's current altitude. Furthermore, considering the scenario where the UAV's current altitude is lower than the altitude of the return position, flying at the current altitude may lead to collision with obstacles or loss of control due to obstruction by obstacles. To further enhance the UAV's return safety, when the distance between the current position of the UAV and the return position is less than the distance threshold, and the UAV's current altitude is lower than the altitude of the return position, the return altitude of the UAV is determined based on the altitude of the return position and a preset safety altitude difference. The return path includes the UAV ascending to the return altitude and flying in a straight line to a position directly above the return position. The preset safety altitude difference provides altitude error compensation, further reducing the probability of the UAV encountering obstacles. When the current altitude of the UAV is higher than the altitude of the return position, the return path includes flying in a straight line to a position directly above the return position at the UAV's current altitude, thereby ensuring the safety of the UAV's return.

Exemplarily, if the distance between the current position of the UAV and the return position is greater than or equal to the distance threshold, a sufficiently high return altitude can be predefined to avoid most obstacles. This return altitude can be set by the user or predetermined before the UAV leaves the factory. The return path includes the UAV ascending to the predetermined return altitude and flying in a straight line to a position directly above the return position at the predetermined return altitude, thereby ensuring the safety of the UAV's return.

It is understood that the distance threshold can be specifically set based on the actual application scenario, with no restrictions imposed herein. For instance, if the distance threshold is set to 50 meters, when the distance between the current position of the UAV and the return position is greater than or equal to 50 meters, the UAV can ascend vertically to the user-defined return altitude before commencing the return journey. If the current altitude is already higher than the set return altitude, indicating sufficient safety, the UAV can return at its current altitude. When the distance between the current position of the UAV and the return position is less than 50 meters, the UAV returns at the current altitude or it can return based on a return altitude determined by the difference between the current altitude of the UAV and the altitude of the return position.

In some exemplary embodiments, if the obstacle avoidance sensor of the UAV fails during flight, considering that the historical flight trajectory of the UAV has demonstrated sufficient safety, the UAV can plan its return path in real-time based on its historical flight trajectory from the current position to the return position, thereby ensuring the safety of the return journey. For example, if the obstacle avoidance sensor includes a vision sensor and the current environment's brightness does not meet the working conditions of the vision sensor, the UAV can utilize its historical flight trajectory to plan the return path in real-time and achieve a return along the original path.

In some exemplary embodiments, in cases where the historical flight trajectory of the UAV is winding, resulting in a return path planned based on this trajectory not being the shortest, leading to increased battery consumption, the UAV can adopt a strategy where it flies along the historical flight trajectory for a certain distance before proceeding with a straight-line return. In this way, part of the return path can be planned based on the historical flight trajectory, while another part can be planned based on the distance between the UAV's current position and the return position. This approach can improve the efficiency of the UAV's return and reduce energy consumption during the return journey.

In one example, in the event of sensor failure for obstacle avoidance, such as when the current environmental light brightness does not meet the working conditions of the vision sensor, part of the return path can be planned based on the historical flight trajectory, while another part can be planned based on the distance between the UAV's current position and the return position. During the return process, the UAV flies in the opposite direction along the historical flight trajectory for a predetermined distance, then transitions into straight-line return. During the straight-line return, if the distance between the UAV's current position and the return position is less than a distance threshold, the return path includes flying straight up to the return position at the UAV's current altitude. If the distance between the UAV's current position and the return position is greater than or equal to the distance threshold, the return path includes flying up to a predetermined return altitude and then flying straight to the return position at that altitude.

In some exemplary embodiments, two return modes can be set based on whether the obstacle avoidance sensor is working. The first return mode indicates that when the obstacle avoidance sensor is operating normally, the UAV plans a safe and shortest return path in real-time based on the detection data of the sensor, which helps save power consumption and improve return efficiency. The second return mode indicates that when the obstacle avoidance sensor fails, the UAV plans the return path based on the distance between the current position of the UAV and the return position and/or historical flight trajectory to ensure the safety of the return. The UAV can choose different return modes based on whether the obstacle avoidance sensor is functioning or not, thereby integrating both return strategies to balance the UAV's return efficiency and safety.

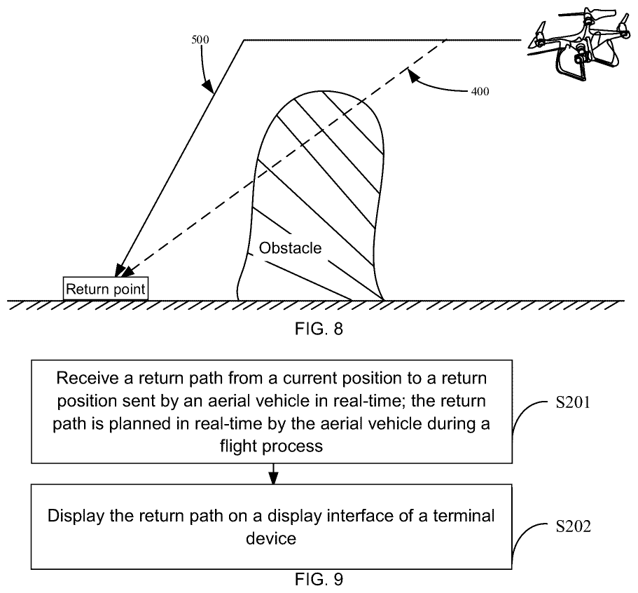

In some exemplary embodiments, during the UAV's return process, when it approaches the return position, the UAV can save power consumption and time by descending while returning, i.e., flying diagonally towards the return position. Referring to FIG. 8, in typical UAV-related technologies, the UAV may start diagonal flight directly when the distance from the UAV's current position to the return position meets a preset distance, or when the line connecting the return position and the UAV's current position satisfies a preset slope, as shown in the diagonal flight trajectory 400 in FIG. 8. However, in the presence of obstacles, this may lead to collisions between the UAV and obstacles during diagonal flight. Therefore, to avoid collisions between the UAV and obstacles during diagonal flight, when the obstacle avoidance sensor is operating normally, the UAV can determine the timing of diagonal descent based on the detection data of the sensor. As shown in FIG. 8, when the UAV approaches the return position, if the detection data of the sensor determines that there is an obstacle between the current position and the return position, indicating that diagonal descent is not suitable, the UAV continues to fly along the planned path until the detection data of the sensor confirms that there are no obstacles affecting diagonal descent between the current position and the return position. At this point, the UAV can determine the timing for diagonal descent and descend diagonally to the return position, as shown in the diagonal flight trajectory 500 in FIG. 8. The timing of diagonal descent determined based on the detection data of the sensor ensures that the UAV does not collide with obstacles during diagonal flight, thereby enhancing the safety of the UAV's return.

In some exemplary embodiments, during the UAV's flight mission, when there are numerous obstacles in the UAV's environment or when the UAV is close to obstacles, it may not be able to plan a return path from its current position to the return position. If it is unable to plan such a return path, the UAV can send a second indication message to the terminal device. This message prompts the terminal device to display on the display interface/screen that autonomous return cannot be executed and suggests manual return, thereby ensuring the safety of the UAV's return. The displayed message may include visual or auditory information, among other possibilities.

Exemplarily, during user-controlled flight of the UAV via the terminal device, the UAV can receive flight control commands sent by the terminal device. It then determines the predicted flight path of the UAV based on these commands and dynamically plans the return path in real-time from the path points on the predicted flight path to the return position in real time. If it is unable to plan a return path from the path points on the predicted flight path to the return position, it sends a second indication message to the terminal device. This prompts the terminal device to display on the display interface/screen a message indicating that autonomous return may not be possible and suggesting manual return. The displayed message may include visual or auditory information. In some exemplary embodiments, real-time environmental information can be obtained for path planning, allowing timely alerts to users about the possibility of being unable to return due to the current actions. For example, experienced pilots may be adept at flying UAVs in dense environments but may need to manually control the UAV's return due to safety considerations. Therefore, such notifications can help users allocate sufficient time for manual UAV return.

In some exemplary embodiments, the UAV also sends its real-time position to the terminal device so that the device can display the real-time position on the display interface, allowing users to stay informed about the UAV's current location. For example, the UAV continuously plans the return path in real-time and sends it to the terminal device at a first frequency. At the same time, it obtains its real-time position and sends it to the terminal device at a second frequency. Typically, the time required for return path planning is longer than the time needed for obtaining the real-time position, so the second frequency is higher than the first frequency.

Correspondingly, with reference to FIG. 9, the present disclosure also provides a return method for a UAV, which is applied to a terminal device of the UAV, including:

Step S201, receiving a return path from a current position to a return position sent by a UAV in real-time; the return path being planned in real-time by the UAV during a flight process.

Step S202, displaying the return path on a display interface of the terminal device.

In some exemplary embodiments, displaying the return path on the display interface includes: in response to the UAV return trigger instruction, displaying the return path on the display interface.

Since the UAV continuously plans the return path in real-time and sends it to the terminal device, the terminal device can respond to the UAV return trigger instruction by displaying the latest received return path on the display interface. Additionally, during the return process, the terminal device can also display subsequent updated return paths on the display interface.

The conditions triggering the UAV return include: user-initiated UAV return, the UAV's remaining battery level falling below the low power threshold, or loss of connection between the UAV and the terminal device. In some exemplary embodiments, displaying the return path on the terminal device during UAV return allows users to promptly understand the UAV's return status based on the return path. Even in cases of loss of connection between the UAV and the terminal device, the terminal device can still display the return path based on the previously received information, thereby enhancing the safety of the UAV return.

In some exemplary embodiments, the UAV is equipped with sensors capable of obstacle avoidance. The return path is planned in real-time based on the detection data from these sensors when they are functioning normally. The method further includes: during the UAV's return, sending a first control command and/or a second control command to the UAV; or alternatively, not sending the first control command to the UAV. The first control command is used to control the direction of the UAV's head, lateral (left and right) flight, or flight altitude, while the second control command is used to control the flight speed. In some exemplary embodiments, considering the complexity of the flight environment, overlaying user-imposed control commands related to changing attitude during the return along the planned path may cause the UAV to fly to extreme positions where it cannot return or may collide with obstacles. Therefore, during the execution of the return, the UAV does not respond to the first control command, meaning user operations can control the UAV's flight speed along the return path but cannot control the orientation/direction of the head, the lateral flight, or the flight altitude, thereby ensuring the safety of the UAV's return.

In some exemplary embodiments, it further includes: receiving a first indication message sent by the UAV and outputting a prompt message indicating an increase in power consumption based on the first indication message, where the first indication message is sent by the UAV when the difference between a speed indicated by the second control command and the preset speed is greater than a speed difference threshold. The prompt message includes, but is not limited to, visual or auditory information.

In some exemplary embodiments, the UAV plans the return path at a first frequency. The method further includes: receiving the real-time position of the UAV sent by the UAV at a second frequency, where the second frequency is greater than the first frequency.

In cases where the second frequency is greater than the first frequency, it is possible that the latest real-time position of the UAV is not the starting point of the latest return path. For this scenario, the terminal device can have several display options:

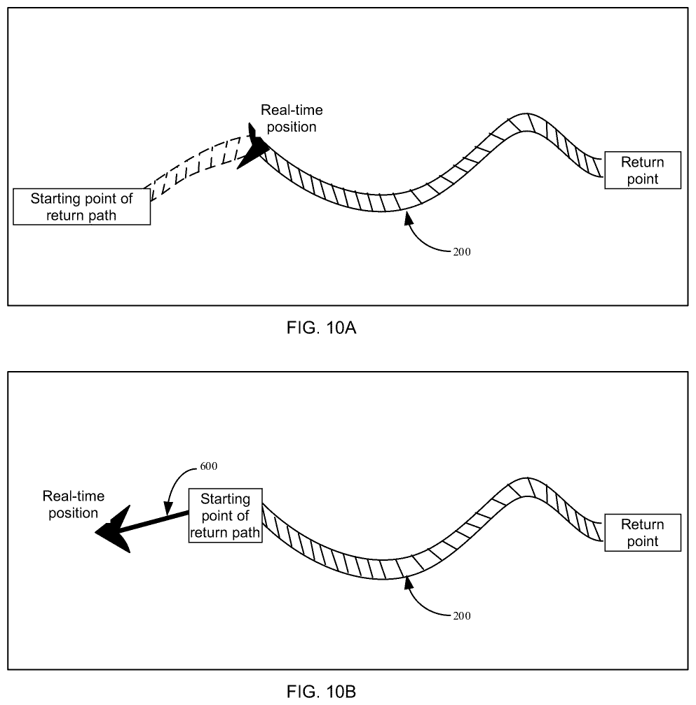

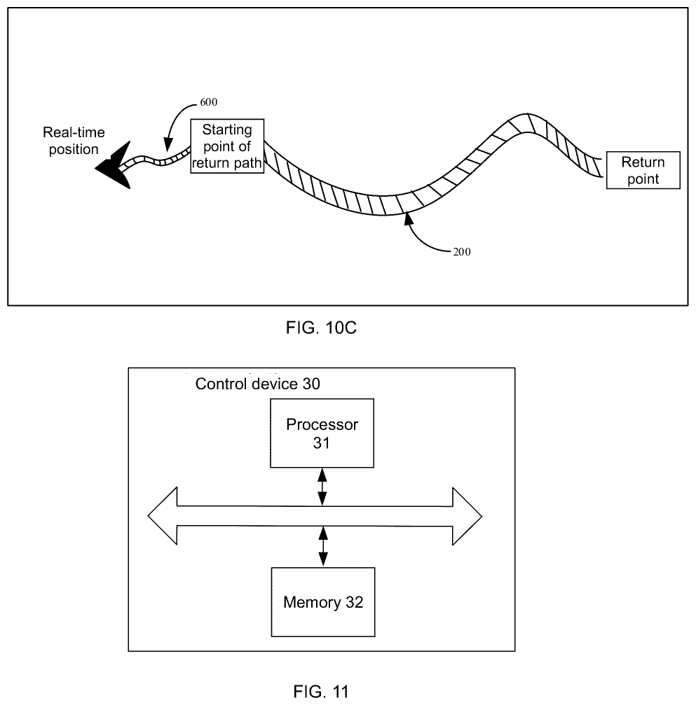

With reference to FIG. 10A, if the latest received real-time position roughly aligns with the latest received return path, indicating that the UAV may have flown a distance along the return path, the terminal device can only display the return path between the latest received real-time position and the return position. The return path between the latest received real-time position and the starting point of the return path (the dashed line portion in FIG. 10A) is not displayed. This allows the user to promptly understand the actual return situation of the UAV. Herein the condition that the latest received real-time position roughly aligns with the latest received return path can include the following cases: the latest received real-time position is on the latest received return path, or the latest received real-time position is near the latest received return path and the distance between them is not greater than a preset deviation distance.

If the most recent received real-time position deviates from the most recent received return path, the terminal device can obtain a segment 600 associated with both and display the segment 600. The segment includes a line connecting the two or a historical flight trajectory between them. For example, if the distance between the most recent received real-time position and the most recent received return path is greater than a preset deviation distance, it determines that the most recent received real-time position deviates from the most recent received return path. For example, the segment associated with the two includes: a line segment between the most recent received real-time position and the path point on the most recent received return path closest to the most recent received real-time position. In one example, if the path point on the most recent received return path closest to the most recent received real-time position is the starting point of the return path, with reference to FIG. 10B, the segment 600 associated with the two can be a line segment between the most recent received real-time position and the starting point of the most recent received return path 200, with reference to FIG. 10C; the segment 600 associated with the two can be the historical flight trajectory between the most recent received real-time position and the starting point of the most recent received return path 200.

Exemplarily, to distinguish the segment 600 associated with the two from the return path 200, the segment 600 associated with the two and the return path 200 can be displayed in different styles, such as different colors, line thicknesses, or line styles.

In some exemplary embodiments, the method further includes: receiving a second indication message sent by the UAV, and based on the second indication message, outputting a prompt message indicating that autonomous return may not be feasible and suggesting manual return. The second indication message is sent by the UAV when it is unable to plan the return path. The prompt message includes, but is not limited to, visual information or auditory information.

Regarding the relevant aspects in the terminal device, reference can be made to the description of the UAV side. It is understood that various technical features in the above exemplary embodiments can be combined, as long as the combination of features does not conflict or contradict each other. Therefore, any combination of various technical features in the above exemplary embodiments also falls within the scope of the present disclosure.

Correspondingly, with reference to FIG. 11, some exemplary embodiments of the present disclosure also provide a control device 30 for a UAV, which includes:
One or more processors 31;
one or more storage media 32 for storing executable instructions for the processors 31;
When the one or more processors 31 execute the executable instructions, they individually or collectively perform the aforementioned return method.

The processors 31 may execute the executable instructions contained in the storage media 32. The processors 31 herein can be a Central Processing Units (CPUs), but may also be other general-purpose processors, Digital Signal Processors (DSPs), Application Specific Integrated Circuits (ASICs), Field-Programmable Gate Arrays (FPGAs), or other programmable logic devices, discrete gates, transistor logic devices, discrete hardware components, etc. The general-purpose processors can be microprocessors or any other conventional processors.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The storage medium/memory 32 stores the executable instructions for the return method. It can include at least one type of storage medium, such as flash memory, hard disk, multimedia card, card-type storage (e.g., SD or DX memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic storage, disk, optical disk, and so on. Additionally, the device can collaborate with network storage devices to perform storage functions through network connections. The storage medium/memory 32 can be an internal storage unit of the control device 30, such as the hard drive or memory of the control device 30. It can also be an external storage device of the control device 30, such as a plug-in hard drive, Smart Media Card (SMC), Secure Digital (SD) card, flash card, etc., equipped on the control device 30. Furthermore, the storage medium/memory 32 may include both internal storage units and external storage devices of the control device 30. The storage medium/memory 32 is used to store executable instructions as well as other programs and data required by the control device 30. It can also be used to temporarily store data that has been or will be output.

The various exemplary embodiments described herein can be implemented using computer-readable media, such as computer software, hardware, or any combination thereof. For hardware implementation, the embodiments described herein can be implemented using at least one of Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), processors, controllers, microcontrollers, microprocessors, or any other electronic unit designed to perform the functions described herein. For software implementation, embodiments such as processes or functions can be implemented with separate software modules that enable the execution of at least one function or operation. Software code can be implemented by software applications (or programs) written in any appropriate programming language, stored in memory, and executed by a controller.

The functionalities and implementations of various units in the aforementioned devices are detailed in the corresponding steps of the methods described above, and are not repeated herein.

Correspondingly, some exemplary embodiments of the present disclosure also provide a UAV, including:
A body;
A propulsion system, located within the body, to provide flight power to the UAV; and
The control device 30, located within the body as shown in FIG. 11.

Exemplarily, the control device 30 can be the flight controller described with FIG. 1.

Correspondingly, some exemplary embodiments of the present disclosure also provide a terminal device, including:
A storage medium for storing executable instructions;
One or more processors;
When the one or more processors execute the executable instructions, they individually or collectively perform the aforementioned return method.

Correspondingly, with reference to FIG. 1, some exemplary embodiments of the present disclosure further provide a flight/aerial system, which includes the aforementioned UAV and the aforementioned terminal device, where the terminal device and the UAV are capable of communicating with each other.

In some exemplary embodiments, a non-transitory computer-readable storage medium containing instructions is also provided. For example, this storage medium may include a memory containing instructions that can be executed by the processor(s) of the device to complete the above method. The non-transitory computer-readable storage medium may include ROM, random-access memory (RAM), CD-ROM, tape, floppy disk, optical data storage devices, and the like.

A non-transitory computer-readable storage medium, when the instructions stored therein are executed by the processor(s) of a terminal, enables the terminal to perform the above methods.

A non-transitory computer-readable storage medium is also provided, when instructions stored on the storage medium are executed by the processor of a terminal, the terminal is enabled to perform the methods as described above.

It should be noted that in the present disclosure, relational terms such as “first” and “second” are used solely to distinguish one entity or operation from another, and do not necessarily imply any actual relationship or order between these entities or operations. Terms such as “comprising,” “including,” or any other variants thereof are intended to encompass non-exclusive inclusion, so that processes, methods, items, or devices including a series of elements include not only those elements explicitly listed, but also other elements not explicitly listed, or even elements inherent to such processes, methods, items, or devices. Unless otherwise specified, the elements defined by the statement “comprising a . . . ” do not exclude other identical elements in the process, method, item, or device comprising these elements.

The methods and devices provided in some exemplary embodiments of the present disclosure have been detailed above, with specific examples used to illustrate the principles and implementations of the present disclosure. The explanations of the above embodiments are provided solely to aid in understanding the methods and core concepts of the present disclosure. Additionally, for a person skilled in the art, changes may be made to the specific exemplary embodiments and applications based on the principles of the present disclosure. Therefore, the content of the present disclosure should not be construed as limiting the scope of the present disclosure.

What is claimed is:

1. A return method for an aerial vehicle, comprising:
during a flight process of the aerial vehicle, performing real-time planning of a return path from a current position to a return position; and
performing real-time transmission of the return path to a terminal device to display the return path on a display interface.

2. The method according to claim 1, wherein the terminal device is configured to display the return path on the display interface in response to an aerial vehicle return trigger instruction.

3. The method according to claim 2, wherein a condition for triggering the aerial vehicle return includes at least one of: a user actively triggering a return, a remaining power of the aerial vehicle is lower than a low power threshold, or the aerial vehicle losing contact with the terminal device.

4. The method according to claim 1, wherein the aerial vehicle is equipped with a sensor for obstacle avoidance; and the performing of the real-time planning of the return path from the current position to the return position includes:
planning in real-time the return path from the current position to the return position based on detection data of the sensor when the sensor has a normal function to enable the aerial vehicle to avoid obstacles during a return process.

5. The method according to claim 1, wherein the sensor includes a vision sensor; and the performing of the real-time planning of the return path from the current position to the return position includes:
in response to a light brightness of an environment where the aerial vehicle is located meets a working condition of the vision sensor, performing the real-time planning of the return path from the current position to the return position.

6. The method according to claim 4, further comprising: during the return process:
the aerial vehicle refusing to respond to a first control command, sent by the terminal device, for controlling a heading direction of the aerial vehicle, a left or right flight of the aerial vehicle, or a flight altitude of the aerial vehicle; or
the aerial vehicle responding to a second control command, sent by the terminal device, for controlling a flight speed of the aerial vehicle, and sending a first indication message to the terminal device to inform an increase in power consumption upon determining that a difference between a speed indicated by the second control command and a preset speed exceeds a speed difference threshold, wherein the preset speed indicates a flight speed corresponding to a maximum flight range of the aerial vehicle.

7. The method according to claim 4, wherein the planning in real-time the return path from the current position to the return position based on the detection data of the sensor includes:
determining a grid map and a road network map of an environment where the aerial vehicle is located based on the detection data of the sensor; and
planning the return path of the aerial vehicle from the current position to the return point in real time based on the grid map and the road network map, wherein
the grid map includes at least one grid, and each grid corresponds to a first parameter to characterize a security risk of passing through the grid, the road network map includes at least one edge, and each edge corresponds to a second parameter to characterize a security risk of passing through the edge.

8. The method according to claim 7, wherein the planning of the return path of the aerial vehicle from the current position to the return point in real time based on the grid map and the road network map includes:
performing, based on a searching method, a path search in the grid map and the road network map to obtain the return path; and
optimizing, based on a sampling method, the return path in the road network map.

9. The method according to claim 4, wherein the performing of the real-time planning of the return path from the current position to the return position includes:
planning the return path from the current position to the return position in real-time based on a distance between the current position and the return position or based on a historical flight trajectory of the aerial vehicle, when the sensor fails.

10. The method according to claim 1, wherein the return path is planned in real-time at a first frequency and transmitted to the terminal device; the method further comprises:
transmitting a real-time position of the aerial vehicle to the terminal device at a second frequency to display the real-time position on the display interface, wherein
the second frequency is greater than or equal to the first frequency.

11. The method according to claim 1, further comprising:
during a return process, determining, when the aerial vehicle approaches the return position, a timing for initiating a diagonal descent of the aerial vehicle based on detection data of a sensor.

12. The method according to claim 1, further comprising:
sending a second indication message to the terminal device, when it is not possible to plan the return path from the current position to the return position, to at least informing that autonomous return is not executable, or suggesting manual return.

13. The method according to claim 1, further comprising:
obtaining a flight control command sent by the terminal device;
determining a predicted flight path of the aerial vehicle based on the flight control commands;
performing real-time planning of the return path from points on the predicted flight path to the return position; and
sending a second indication message to the terminal device, when it is not possible to plan the return path from the points on the predicted flight path to the return position, to inform that autonomous return is not executable and suggest manual return.

14. The method according to claim 1, wherein the performing of the real-time planning of the return path from the current position to the return position includes at least one of:
performing, after the aerial vehicle takes off, the real-time planning of the return path from the current position to the return position;
performing, prior to triggering an aerial vehicle return, the real-time planning of the return path from the current position to the return position; or
performing, upon determining that a distance between the aerial vehicle and the return position is greater than a distance threshold, the real-time planning of the return path from the current position to the return position.

15. A return method applicable to a terminal device of an aerial vehicle, comprising:
receiving a return path from a current position of the aerial vehicle to a return position sent in real-time by the aerial vehicle, wherein the return path is planned in real-time by the aerial vehicle during a flight process; and
displaying the return path on a display interface of the terminal device.

16. The method according to claim 15, wherein the displaying of the return path on the display interface of the terminal device includes:
in response to an aerial vehicle return trigger instruction, displaying the return path on the display interface, wherein a condition for triggering the aerial vehicle return includes at least one of: a user actively triggering a return, a remaining power of the aerial vehicle is lower than a low power threshold, or the aerial vehicle losing contact with the terminal device.

17. The method according to claim 14, wherein the return path is planned in real time by the aerial vehicle at a first frequency, and the method further comprises:
receiving a real-time position of the aerial vehicle transmitted by the aerial vehicle at a second frequency, wherein the second frequency is greater than or equal to the first frequency.

18. The method according to claim 14, further comprising:
receiving a real-time position of the aerial vehicle; and
performing at least one of the following:
in response to a latest received real-time position of the aerial vehicle being on a latest received return path, displaying the return path between the latest received real-time position of the aerial vehicle and the latest received return path, or
in response to a latest received real-time position of the aerial vehicle being deviated from a latest received return path, obtaining and display a line segment associating the latest received real-time position and the latest received return path, wherein the line segment includes a line connecting the latest received real-time position and the latest received return path or a historical flight trajectory.

19. The method according to claim 14, further comprising:
receiving a second indication message sent by the aerial vehicle; and
outputting a prompt message indicating that autonomous return is not executable and suggesting manual return, wherein the second indication message is sent by the aerial vehicle upon determining that the aerial vehicle is unable to plan the return path.

20. An aerial vehicle, comprising:
a body;
a propulsion system located within the body to provide flight power to the aerial vehicle; and
a control device within the body, including:
at least one storage medium storing at least one set of instructions for aerial vehicle return; and
at least one processor in communication with the at least one storage medium, wherein during operation, the at least one processor executes the at least one set of instructions to cause the control device to at least:
during a flight process of the aerial vehicle, perform real-time planning of a return path from a current position to a return position, and
perform real-time transmission of the return path to a terminal device to display the return path on a display interface.
